(19) United States
(12) Patent Application Publication
(10) Pub. No.: US 2019/0134913 A1
(43) Pub. Date: May 9, 2019

(54) 3D PRINTER WITH INDEPENDENT MULTI ZONE TEMPERATURE CONTROLLER

(71) Applicant: SABIC Global Technologies B.V., Bergen op Zoom (NL)

(72) Inventor: Matthew Buratto, Lee, MA (US)

(21) Appl. No.: 16/096,476

(22) PCT Filed: Apr. 27, 2017
(86) PCT No.: PCT/US2017/029936

§ 371 Date: Oct. 25, 2018

Related U.S. Application Data
(60) Provisional application No. 62/328,256, filed on Apr. 27, 2016.

(51) Int. Cl. B29C 64/393; B33Y 10/00; B33Y 30/00; B33Y 50/02; B29C 64/118; B29C 64/209; B29C 64/236; B29C 64/295; B29C 64/245

(52) U.S. Cl. CPC B29C 64/393; B33Y 10/00; B33Y 30/00; B33Y 50/02; B29C 64/245; B29C 64/209; B29C 64/236; B29C 64/295; B29C 64/118

(57) ABSTRACT

A three dimensional (3D) printer includes a substrate plate, a plate heater, a metal plate, and a multi zone temperature controller. The metal plate, adjustable along a z-axis, supports the substrate plate, and the metal plate is thermally coupled to the plate heater. The extruder is supported by a translation stage configured to move the extruder about an x-y plane, orthogonal to the z-axis, to positions above the substrate plate. The extruder includes a nozzle having a nozzle heater capable of heating the nozzle to at least 200° C.; and a heat tolerant filament drive mechanism to feed a printing material filament towards the nozzle. The multi zone temperature controller is coupled to the plate heater and the nozzle heater to independently control temperatures of the plate heater and the nozzle heater to facilitate extrusion of the printing material filament through the nozzle.

### RELATED APPLICATION

This application claims priority to U.S. Provisional Application Ser. No. 62/328,256 (entitled 3D Printer with Independent Dual Zone Temperature Controller, filed Apr. 27, 2016) which is incorporated herein by reference.

### BACKGROUND

Three dimensional (3D) printers may be designed with a controller that includes temperature limits on an extruder nozzle heater that are bounded to ensure that printers operate within the temperature conditions that printer components can tolerate. This can become problematic as new printing materials become available that may require higher temperatures to melt to a temperature suitable for extruding the material from the heated nozzle for printing a 3D structure. Such 3D printers may not be able to utilize the newer printing materials due to controller programmed temperature constraints.

### SUMMARY

One embodiment is directed to a three dimensional (3D) printer comprising a substrate plate; a plate heater; and a metal plate, adjustable along a z-axis, having a first major surface and a second major surface opposite the first major surface, wherein the first major surface supports the substrate plate, and wherein the metal plate is thermally coupled to the plate heater. An extruder is supported by a translation stage and is configured to move the extruder about an x-y plane, orthogonal to the z-axis, to positions above the substrate plate. The extruder includes a nozzle having a nozzle heater capable of heating the nozzle to at least 200° C.; and a heat tolerant filament drive mechanism to feed a printing material filament towards the nozzle. A multi zone temperature controller is coupled to the plate heater and the nozzle heater to independently control temperatures of the plate heater and the nozzle heater to facilitate extrusion of the printing material filament through the nozzle at a temperature exceeding 200° C. and onto the substrate plate that is heated by the plate heater to produce 3D structures.

In other embodiments, a three dimensional (3D) printer includes a z-height adjustable hardened steel plate supporting a glass plate and thermally coupled to a plate heater. An extruder is supported by an x-y translation stage to move the extruder to different positions above the glass plate, the extruder including a nozzle having a nozzle heater capable of heating the nozzle to at least 200° C., and the extruder further including a heat tolerant filament drive mechanism to feed a printing material filament towards the nozzle. A multi zone temperature controller is coupled to the plate heater and the nozzle heater to independently control the temperatures of both heaters to facilitate extrusion of the printing material filament through the nozzle at temperatures exceeding 200° C. onto the glass plate that is heated by the hardened steel plate heater to produce 3D structures.

One embodiment relates to a method of printing a 3D structure, the method comprising adjusting, with a printer controller, a height of a z-height adjustable metal plate, the metal plate thermally coupled to a plate heater and a substrate plate. The method includes positioning, with the printer controller, an extruder, supported by an x-y translation stage, to positions above the substrate plate, the extruder including a nozzle having a nozzle heater capable of heating the nozzle to at least 200° C. The method also includes controlling, using the printer controller, a heat tolerant filament drive mechanism to feed a printing material filament towards the nozzle. The method also includes independently controlling, using an independent multi zone temperature controller coupled to the metal plate heater and the nozzle heater, the temperatures of the plate heater and nozzle heater to facilitate extrusion of the printing material filament through the nozzle at temperatures exceeding 200° C. onto the substrate plate that is heated by the plate heater to produce 3D structures.

Other embodiments relate to a method of printing a 3D structure includes using a printer controller to adjust a height of a z-height adjustable hardened steel plate supporting a glass plate and thermally coupled to a plate heater, using the printer controller to move an extruder supported by an x-y translation stage to different positions above the glass plate, the extruder including a nozzle having a nozzle heater capable of heating the nozzle to at least 200° C., using the printer controller to control a heat tolerant filament drive mechanism to feed a printing material filament towards the nozzle, and using an independent multi zone temperature controller coupled to the hardened steel plate heater and the nozzle heater to independently control the temperatures of the plate heater and nozzle heater to facilitate extrusion of the printing material filament through the nozzle at temperatures exceeding 200° C. onto the glass plate that is heated by the hardened steel plate heater to produce 3D structures.

Still other embodiments relate to a 3D printing system comprising a substrate plate; a plate heater; and a metal plate, adjustable along a z-axis, having a first major surface and a second major surface opposite the first major surface, wherein the first major surface supports the substrate plate, and wherein the metal plate is thermally coupled to the plate heater. An extruder is supported by a translation stage configured to move the extruder about an x-y plane, orthogonal to the z-axis, to positions above the substrate plate. The extruder includes a nozzle having a nozzle heater capable of heating the nozzle to at least 200° C.; and a heat tolerant filament drive mechanism to feed a printing material filament towards the nozzle. A printer controller is coupled to receive a digital 3D file and control a z-height of the metal plate, the translation stage, and the heat tolerant filament drive mechanism as a function of the digital 3D file. A multi zone temperature controller including temperature sensors, is coupled to the plate heater and the nozzle heater to independently control temperatures of the plate heater and the nozzle heater to facilitate extrusion of the printing material filament through the nozzle at a temperature of at least 200° C. (e.g., a temperature of at least 250° C., at least 300° C. at least 350° C. or at least 400° C.) onto the substrate plate that is heated by the plate heater to a temperature of between 200-300° C. (e.g., 260° C.) to produce 3D structures.

Yet other embodiments relate to a 3D printing system including a z-height adjustable hardened steel plate supporting a glass plate and thermally coupled to a plate heater. An extruder is supported by an x-y translation stage to move the extruder to different positions above the glass plate, the extruder including a nozzle having a nozzle heater capable of heating the nozzle to at least 200° C., the extruder further including a heat tolerant filament drive mechanism to feed a printing material filament towards the nozzle. A printer controller is coupled to receive a digital 3D file and control the z-height of the hardened steel plate, the x-y translation stage, and the heat tolerant filament drive mechanism as a function of the digital 3D file. A multi zone temperature controller including temperature sensors, is coupled to the plate heater and the nozzle heater to independently control the temperatures of both heaters independent of the printer controller, to facilitate extrusion of the printing material filament through the nozzle at temperatures exceeding 200° C. onto the glass plate that is heated by the hardened steel plate heater to produce 3D structures.

### BRIEF DESCRIPTION OF THE DRAWINGS

FIG. 1 is a block diagram representation of a 3D printer with a dual zone temperature controller according to an example embodiment.

FIG. 2 is a block diagram representation of an extruder assembly according to an example embodiment.

FIG. 3 is a flowchart illustrating a method of printing a 3D structure using a dual zone temperature controller according to an example embodiment.

FIG. 4 is a block diagram representation of circuitry for implementing one or more controllers according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Many 3D printers are designed to print using materials that melt at specific temperatures, such as 300° C. or lower. When materials with higher melting points are used, the printers may not be able to melt and apply such materials to a structure being printed. One higher temperature material includes polyetherimides, such as ULTEM® 9085 material available from Sabic-GApt. Such materials may be heated to between approximately 300° C. and 400° C. to perform adequately as a 3D printing material in filament form. The temperature range may vary for different materials and are not exact limits. The limits may be exceeded in various embodiments, but may not provide optimal results. Empirical analyses may be easily performed to determine desired ranges for each new material.

Polyetherimides can comprise polyetherimides homopolymers (e.g., polyetherimidesulfones) and polyetherimides copolymers. The polyetherimide can be selected from (i) polyetherimidehomopolymers, e.g., polyetherimides. (ii) polyetherimide co-polymers, and (iii) combinations thereof. Polyetherimides are known polymers and are sold by SABIC Innovative Plastics under the ULTEM®*, EXTEM®*, and Siltem* brands (Trademark of SABIC Innovative Plastics IP B.V.).

Polyetherimides can be of formula (1):

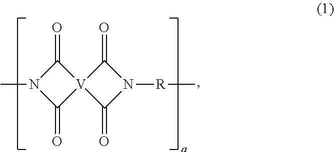

wherein a is more than 1, for example 10 to 1.000 or more, or more specifically 10 to 500.

The group V in formula (1) is a tetravalent linker containing an ether group (a “polyetherimide” as used herein) or a combination of an ether groups and arylenesulfone groups (a “polyetherimidesulfone”). Such linkers include but are not limited to: (a) substituted or unsubstituted, saturated, unsaturated or aromatic monocyclic and polycyclic groups having 5 to 50 carbon atoms, optionally substituted with ether groups, arylenesulfone groups, or a combination of ether groups and arylenesulfone groups: and (b) substituted or unsubstituted, linear or branched, saturated or unsaturated alkyl groups having 1 to 30 carbon atoms and optionally substituted with ether groups or a combination of ether groups, arylenesulfone groups, and arylenesulfone groups; or combinations comprising at least one of the foregoing. Suitable additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (2):

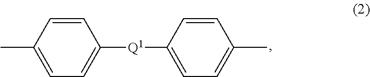

wherein Q1 includes but is not limited to a divalent moiety such as —O—, —S—, —C(O)—, —SO2-, —SO—, —CyH2y- (y being an integer from 1 to 5), and halogenated derivatives thereof, including perfluoroalkylene groups.

The linker V may include but are not limited to tetravalent aromatic groups of formula (3):

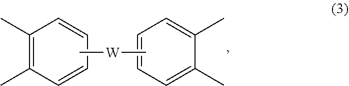

wherein W is a divalent moiety including —O—, —SO2-, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent groups of formulas (4):

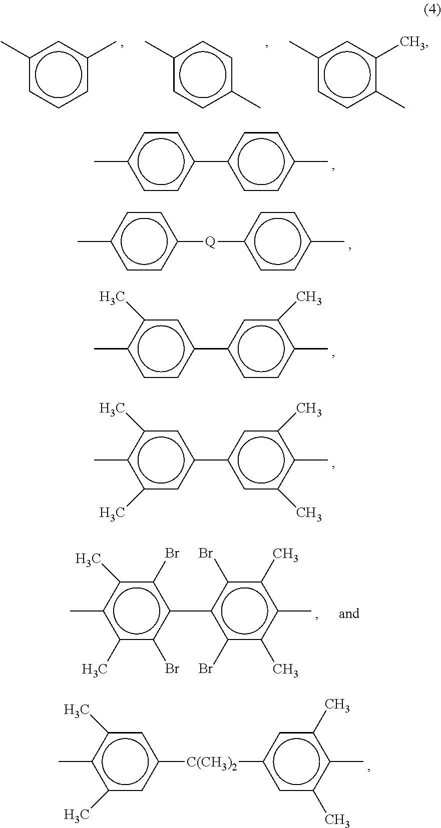

wherein Q includes, but is not limited to a divalent moiety including —O—, —S—, —C(O).
—SO₂—, —SO—, —C_{y}H_{2y}— (y being an integer from 1 to 5), and halogenated derivatives thereof, including perfluoroalkylene groups.

Polyetherimide may comprise more than 1, specifically 10 to 1,000, or more specifically, 10 to 500 structural units, of formula (5):

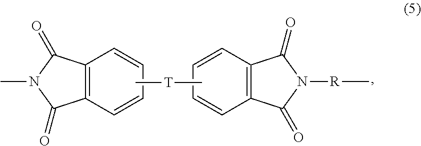

wherein T is —O— or a group of the formula —O—Z—O— wherein the divalent bonds of the —O— or the —O—Z—O— group are in the 3,3′, 3,4′, 4,3′, or the 4,4′ positions; Z is a divalent group of formula (3) as defined above; and R is a divalent group of formula (2) as defined above.

In some embodiments, the thermoplastic composition comprises a bi-, tri-, or other multi-modal distribution of polyetherimides, e.g., a bi-modal distribution of polyetherimide polymers. The modes of the distribution may be equal to one another, e.g., half of the composition comprises PEI of MW₁, and the other half of the composition comprises PEI of MW₂. The width of a distribution (mode) may be such that 1%-99% of the PEI in that mode is within 10% of the weight average molecular weight for that mode.

The first and second populations may differ in molecular weight by, e.g., from about 1 to about 90 kDa. or from about 15 to about 85 kDa, or from about 20 to about 80 kDa, or from about 25 to about 75 kDa, or from about 30 to about 65 kDa, or from about 35 to about 60 kDa, or from about 40 to about 65 kDa. or from about 45 to about 60 kDa, or from about 50 to about 55 kDa. Populations that differ in molecular weight by from about 10 to about 25 kDa (e.g., from about 15 kDa to about 24 kDa) are considered especially suitable.

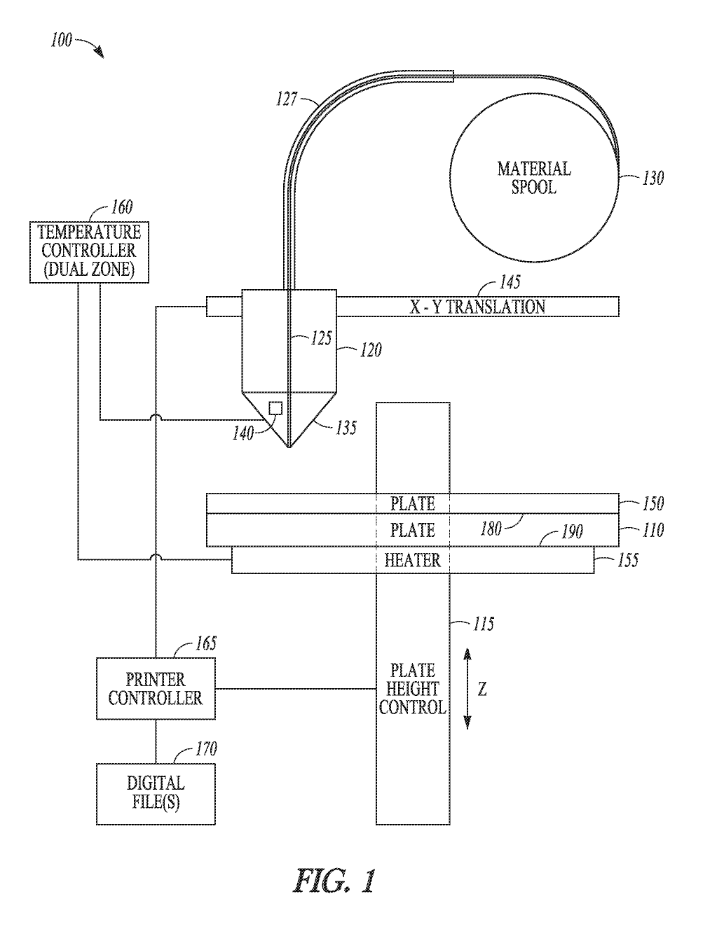

FIG. 1 is a block diagram of a 3D printer indicated generally at 100 according to an example embodiment. The block diagram illustrates some of the basic components of a 3D printer that enable a 3D structure to be printed. In one embodiment, a plate 110 is supported on a plate height adjusting control 115 that moves the plate up and down with respect to an extruder 120 that extrudes printing material derived by heating a material filament 125 running through a feeder tube 127. The plate height adjusting control 115 may include a stepper motor in one embodiment for controlling the plate height along a guide structure. The material filament 125 may be spooled at a spool 130 to provide sufficient material for printing one or more 3D structures.

The extruder 120 in one embodiment includes a nozzle 135 having a nozzle heater 140. The nozzle heater 140 is adapted to provide an amount of heat suitable for high temperature filament materials in one embodiment, such as temperatures above 300° C. and at least up to 400° C. For ULTEM grade materials the nozzle temperature may be set to 300° C. or higher to facilitate printing of such materials. If heated to too low a temperature, the filament does not extrude. If too high, the material degrades, carbon buildup may occur, and the nozzle may become clogged. The nozzle temperature may be adjusted accordingly for each material to find optimal temperatures for such materials while avoiding temperatures that are too high or too low.

In some embodiments, the extruder can be a dual extruder, though triple, quadruple, and more extruders are also contemplated. For example, a dual extruder can comprise two side-by-side nozzles, each nozzle having its own, independently-controlled heater. Each nozzle heater is adapted to provide a suitable amount of heat to, e.g., melt high temperature filament materials in one embodiment, such as temperatures above 300° C. and at least up to 400° C. For ULTEM grade materials the each nozzle temperature may be independently set to the same or different temperatures (e.g., 300° C. or higher to facilitate printing of ULTEM materials). The nozzle temperature for each nozzle may be adjusted accordingly and independently for each material to find optimal temperatures for various materials. The material extruded by each nozzle can be the same or different.

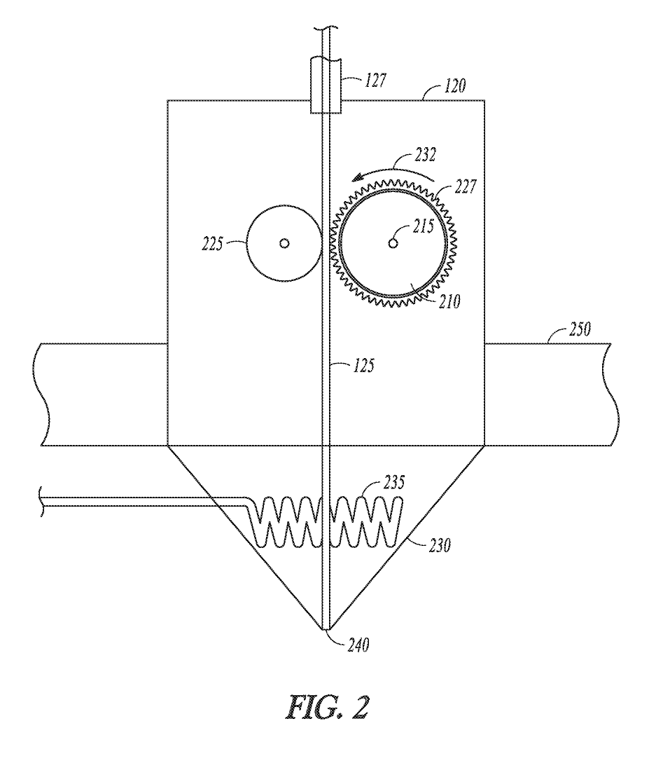

The 3D printer of the various embodiments described herein can comprise an air heater configured to heat the extruded material between the nozzle and the substrate plate. The air heater can be located in any suitable location so long as it can heat (e.g., melt) the extruded material between the nozzle and the substrate plate. For example, the air heater can be located and coupled to the nozzle carriage assembly 250 (see FIG. 2) that is used to couple the extruder 120 and cartridge to the x-y translation stage 145. The air heater can also take any suitable configuration, including a coil.

Parts printed using an air heater can have improved mechanical properties in the XY orientation (e.g., tensile modulus as determined using ASTM D638; tensile strength as determined using ASTM D638; and Izod impact strength as determined using ASTM 256) over parts printed without an air heater. For example, the tensile modulus can be improved by about 5% to about 30% (e.g., about 5% to about 10%; about 5% to about 15%; or about 10% to about 25%) or more over parts printed without an air heater. In other examples, the Izod impact strength can be improved by about 5% to about 50% (e.g., about 5% to about 10%; about 5% to about 15%; about 10% to about 25%; about 20% to about 40%; or about 15% to about 45%) or more over parts printed without an air heater.

While not wishing to be bound by any specific theory, it is believed that the air heater improves the adhesion of subsequently deposited material to previously deposited material, which is heated (e.g., softened or melted) by the air heater prior to the deposition of additional material.

The effect of the air heater can be achieved with other devices, such as an optical radiation source configured to heat the extruded material prior to the deposition of additional material. Suitable optical radiation sources include, e.g., a suitably configured infrared laser, which is aimed at and heats (e.g., soften or melt) newly-deposited material before more additional material is extruded thereon.

The nozzle heater 140 melts the filament material 125 and the nozzle 135 is moved on an x-y translation stage 145 to deposit material on a substrate plate or sheet 150 supported by the plate 110. A 3D structure described in a digital file may be printed by moving the nozzle 135 with respect to a substrate plate 150, and gradually moving the substrate plate lower with respect to the nozzle to print multiple layers. In some embodiments, the substrate plate is a glass plate or a polymeric plate. If the substrate plate is a polymeric plate it is made of a material that does not melt or warp at temperatures exceeding 100° C. (e.g., at a temperature of 140° C. but less than 180° C.). An example of a polymeric plate is a plate made of polycarbonate or ULTEM.

Parts printed using a substrate plate 150 made of glass can have improved mechanical properties in the XY orientation (e.g., tensile modulus as determined using ASTM D638; tensile strength as determined using ASTM D638; and Izod impact strength as determined using ASTM 256) over parts printed with, e.g., a polymeric plate. For example, the tensile modulus can be improved by about 5% to about 30% (e.g., about 5% to about 10%; about 5% to about 15%; or about 10% to about 25%) or more over parts printed without an air heater. In other examples, the Izod impact strength can be improved by about 5% to about 50% (e.g., about 5% to about 10%; about 5% to about 15%; about 10% to about 25%; about 20% to about 40%; or about 15% to about 45%) or more over parts printed with, e.g., a polymeric plate.

While not wishing to be bound by any specific theory, it is believed that because a substrate plate 150 made of glass is heated to higher temperatures (e.g., at temperatures of about 200° C. to about 350° C.), the higher temperatures improve the adhesion of subsequently deposited material to previously deposited material, which is heated (e.g., softened or melted) by the heat of the glass plate prior to the deposition of additional material.

In one embodiment, a plate heater 155 is thermally coupled to the plate 110 such as by using Momentive RTV106 which conforms to MIL-A46106B. The plate heater 155 serves to heat both the plate 110 and the glass plate 150 during printing. A multi zone (e.g., dual zone) temperature controller 160 may be coupled to both nozzle heater 140 and plate heater 155 to independently control the temperatures of both heaters such that they may be controlled to different set points. In one embodiment, the multi zone temperature controller 160 includes temperature sensors coupled to provide sensed temperature information to circuitry in the controller 160 that may be programmed to independent set points. The circuitry may implement a control algorithm such as any combination of proportional, integral, and derivative algorithms. The use of an independent temperature controller to one or more nozzle heaters (e.g., when the extruder is a dual extruder) and the plate heater provides the ability to easily conduct experiments to determine suitable temperature ranges for higher temperature materials, since the temperature ranges are easily changed within the independent multi zone temperature controller 160.

In one embodiment, the plate 110 comprises a hardened steel plate. Hardened steel is usually a medium or high carbon content steel that has been heat treated to very high temperatures, followed by quenching and tempering to create a hard steel that does not warp when subjected to high temperatures. The quenching results in formation of metastable martensite. In one embodiment, plate 110 is formed of h-13 steel which is hardened to 50-52 Rockwell C. The hardening process may involve at least two heating cycles over two days, such as heating to about 750° C. (e.g., about 760° C.) then cooling and heating again to about 430° C. (e.g., about 426° C.), followed by a slow cool down. Hardened steel provides a stable platform even at higher temperatures that may be used to print using high temperature materials like ULTEM 9085 and other ULTEM grade materials, as well as polycarbonate, polyether ketone (PEEK) and other high temperature materials.

The plate 110 can be solid or, in some embodiments, machined to include one or more orifices (not shown) extending from the metal plate first major surface 180 to the metal plate second major surface 190. In some embodiments, the one or more orifices are fluidly coupled to a vacuum system (not shown). In other embodiments, the plate 110 can be machined to have one or more grooves on at least the first major surface 180, the one or more grooves fluidly coupled to the one or more orifices. The one or more orifices, in conjunction with the vacuum system, can serve to hold the plate 150 to the plate 110, particularly when plate 150 is a polymeric plate. The one or more grooves on at least the first major surface 180, the one or more grooves fluidly coupled to the one or more orifices, and, the one or more orifices in turn fluidly coupled to a vacuum system, can serve to hold the plate 150 to the plate 180, particularly when plate 150 is a polymeric plate. In some embodiments, when the plate 150 is held under vacuum to the plate 110, there may be less warping or no warping in plate 150, which, in turn, translates to less warping or no warping in the printed part in the region where the extruded material contacts plate 150.

The plate 110 may be coupled to the plate z-height adjusting control 115 via aluminum support arms. The use of a plate 150 (e.g., polymeric or glass) supported by plate 110 (e.g., hardened steel plate), in some embodiments, provides a very flat build surface for printing the 3D structure. And in some embodiments, the plate 110 (e.g., hardened steel plate) helps to prevent warping of the plate 150 responsive to high temperatures. In one embodiment, the plate 150 is a glass plate. In some embodiments, a glass plate can be constructed of high temperature Pyroceram® glass-ceramic material. By not warping, the plate 110 also facilitates uniform heating of the plate 150 by maintaining more uniform contact between the plate 110 and the plate 150, e.g., a temperatures at least up to 200-300° C. (e.g., 260° C.). Heating the plate 150 to higher temps also allows for the higher temperature materials to adhere to the plate 150 and not warp during the build.

In some embodiments, the plate 150 is a polymeric plate. When the plate 150 is a polymeric plate, it can be heated to lower temperatures (e.g., temperatures from about 90° C. to about 200° C., about 90° C. to about 150° C. or about 90° C. to about 100° C.) relative to a glass plate. An advantage of a polymeric plate over a glass plate is that the layers of printed material proximal the polymeric plate will not have a tendency to melt and spread, so as to form an “elephant foot” or oversized base along the perimeter of the printed part that contacts the plate 150.

In one embodiment, the plate heater 155 is a high temp silicone heater pad that is controlled as one zone of the multi zone temperature controller with an external temp controller to overcome previous software limits on a maximum temperatures achievable with some prior 3D printers. Plate heater 155 in one embodiment may heat the plate to temperatures as high as 300° C. (e.g., as high as 275° C.). In one embodiment, plate temperatures are maintained during the printing process between about 200° C. to about 300° C. (e.g., 260° C.) to facilitate sticking/adhesion of ULTEM grade materials to the glass plate. Different plate temperatures may be used for printing different materials and/or when a polymeric plate 150 is used, in further embodiments.

Printer 100 in one embodiment includes a printer controller 165 that is coupled to control the x-y translation stage 145, plate height adjusting control 115 and a motor to drive the filament 125 in extruder 120 to print 3D structures. The printer controller 165 may be a single controller, or multiple controllers operating to collaboratively control the x-y translation stage, plate height adjusting control, and motor.

A 3D structure may be represented by a digital file as indicated at 170. The controller 165 reads the digital file and controls the stage 145, plate height, and motor to move the extruder and corresponding nozzle to print using melted filament 125 on the glass plate 150. By separating the temperature controls from the controller 165, a simpler mechanism is provided for adjusting temperatures outside of ranges that prior controllers 165 were limited to. Such independent adjustment allows for easier testing of newer materials over different temperature ranges. To further facilitate higher temperature ranges, many of the components of the printer 100 have been further modified to avoid adverse effects of higher temperatures.

FIG. 2 is a block diagram illustrating further details of extruder 120. Filament 125 is shown entering the extruder 120 at one end via feeder tube 127. The filament 125 is pulled through the extruder via a filament drive mechanism that includes a drive wheel or gear 210 with a motor to either directly drive the gear on an axis 215, or via further gears. A wheel 225 may be positioned with respect to gear 210 to resist movement of the filament 125 away from the gear 210, allowing teeth 227 to retentively engage the filament and pull the filament through the extruder 120 toward a second end containing a nozzle 230 as the gear rotates in a direction represented by arrow 232. The filament 125 in one embodiment may progress toward the second end via a tube, channel, or other structure that guides the filament 125 past the nozzle heater 140, represented as a resistive heater at 235 toward an opening 240, through which melted filament material is extruded to print the 3D structure. In one embodiment, the nozzle is part of a cartridge, and heater 235 may be referred to as a cartridge heater that is selected to provide higher temperatures than previous cartridge heaters in order to deliver the higher melting point filament material at a temperature suitable for 3D printing.

In one embodiment, the extruder 120 is supported by a nozzle carriage assembly 250 that is used to couple the extruder 120 and cartridge to the x-y translation stage 145. In one embodiment, the carriage assembly 250 is formed of aluminum, or any other suitable metal capable of withstanding the temperatures contemplated herein, to avoid melting or other distortion. Since the extruder 120 which includes the nozzle 230, heater 235 and filament drive mechanism, significant heat may be generated, especially when working with higher temperature filament materials.

In a further embodiment, the filament drive mechanism may be formed as an all metal version. Brass, aluminum, steel or other suitable metals, may be used as the metal in some embodiments. Previous drive mechanisms, which used plastic drive wheels, were found to distort due to the heat generated by the nozzle heater and plate heater, and were causing the filament to slip and stop feeding.

The drive wheel 210 on the motor that drives the filament with the drive mechanism has also been improved with the addition of more aggressive teeth 227 for gripping the filament 125. The new drive wheel 210 digs into the filament 125 better to help push the filament through the nozzle and avoid loss of material feed. In some embodiments, the teeth 232 may be angled toward the direction of rotation of the wheel 210, or may simply have steeper sides, corresponding to a smaller angle or sharper peak.

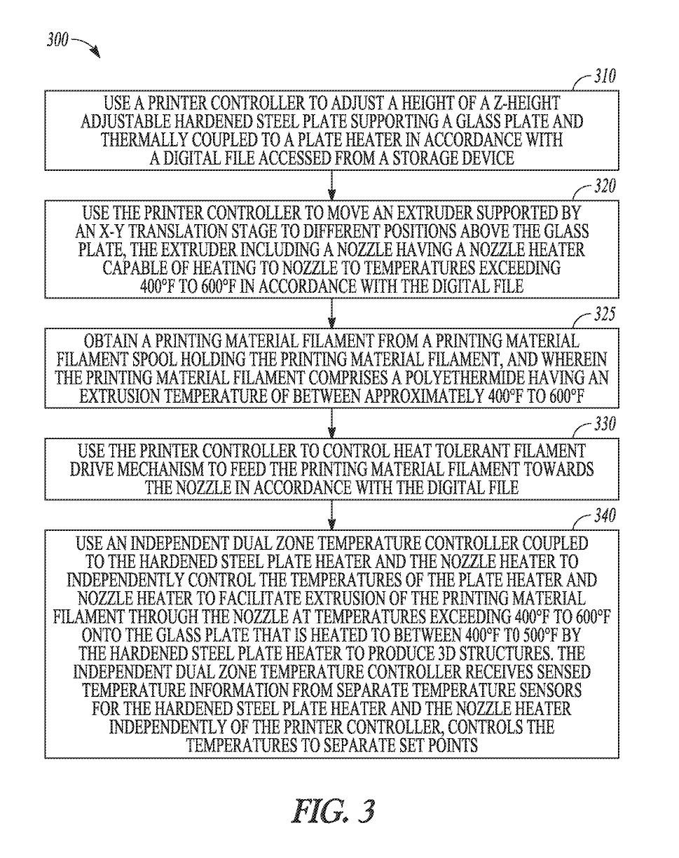

FIG. 3 is a flowchart illustrating one example of a method 300 of printing a 3D structure according to the various embodiments described herein, using a multi zone temperature controller according to an example embodiment. At 310, a printer controller is used to adjust a height of a z-height adjustable hardened steel plate supporting a glass or polymeric plate and thermally coupled to a plate heater. The printer controller is then used at 320 to move an extruder supported by an x-y translation stage to different positions above the glass plate, the extruder including a nozzle having a nozzle heater capable of heating the nozzle to at least 200° C. to 320° C. (e.g., 315° C.) or higher.

At 325, a printing material filament is obtained from a printing material filament spool holding the printing material filament. The printer material filament may comprises a polyetherimide having an extrusion temperature of between 200° C. to 320° C. or higher (e.g., approximately 315° C.) or higher in various embodiments. At 330, the printer controller is used to control a heat tolerant filament drive mechanism to feed a printing material filament towards the nozzle.

At 340, an independent multi zone temperature controller coupled to the hardened steel plate heater and the nozzle heater is used to independently control the temperatures of the plate heater and nozzle heater to facilitate extrusion of the printing material filament through the nozzle at temperatures exceeding 200° C. to 300° C. onto the glass plate that is heated by the hardened steel plate heater to produce 3D structures. The independent multi zone temperature controller may receive sensed temperature information from separate temperature sensors for the hardened steel plate heater and the nozzle heater and independently of the printer controller, controls the temperatures to separate set points.

In one embodiment, the heat tolerant filament drive mechanism comprises metal to minimize distortion of the drive mechanism due to high temperatures, such as temperatures corresponding to heating the nozzle to at least 200° C. and heating the glass plate to at least between 200-300° C. (e.g., 260° C.). In one embodiment, the heat tolerant filament drive mechanism comprises a gear that engages the filament to feed the filament towards the nozzle. The heat tolerant filament drive mechanism in one embodiment comprises a gear having aggressive teeth to dig into the filament to better grip the filament and feed the filament towards the heated nozzle.

The printer controller in one embodiment accesses a digital file from a storage device and wherein the printer controller controls the z-height of the hardened steel plate, the x-y translation stage, and the heat tolerant filament drive mechanism to produce the 3D printed structure as a function of the accessed digital file.

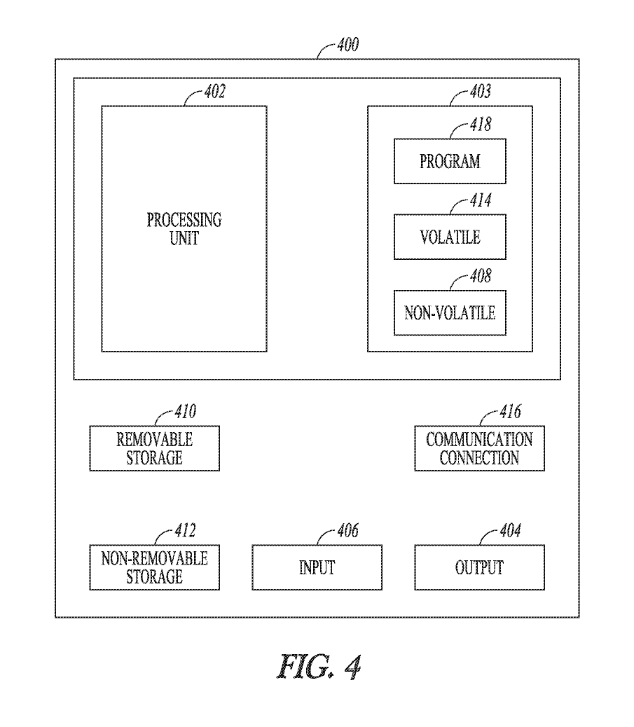

FIG. 4 is a block schematic diagram of circuitry 400 to implement the controllers and methods according to example embodiments. All components, such as removable storage device, need not be used in various embodiments. One example circuitry 400 may include a processing unit 402, memory 403, removable storage 410, and non-removable storage 412. The circuitry in further embodiments may be in the form of an application specific integrated circuit, or a commercial off the shelf microprocessor based controller.

Memory 403 may include volatile memory 414 and non-volatile memory 408. Circuitry 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM). Digital Versatile Disks (DVD) or other optical disk storage, magnetic cassettes, magnetic tape, magnetic disk storage or other magnetic storage devices capable of storing computer-readable instructions for execution to perform functions described herein.

Circuitry 400 may include or have access to a computing environment that includes input 406, output 404, and a communication connection 416. Output 404 may include a display device, such as a touchscreen, that also may serve as an input device. The input 406 may include one or more of a touchscreen, touchpad, mouse, keyboard, camera, one or more device-specific buttons, one or more sensors integrated within or coupled via wired or wireless data connections to the circuitry 400, and other input devices. The computer may operate in a networked environment using a communication connection to connect to one or more remote computers, such as database servers, including cloud based servers and storage. The remote computer may include a personal computer (PC), server, router, network PC, a peer device or other common network node, or the like. The communication connection may include a Local Area Network (LAN), a Wide Area Network (WAN), cellular, WiFi Bluetooth, or other networks.

Computer-readable instructions stored on a computer-readable storage device are executable by the processing unit 402 of the circuitry 400. A hard drive, CD-ROM, and RAM are some examples of articles including a non-transitory computer-readable medium such as a storage device. The terms computer-readable medium and storage device do not include carrier waves. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The following Embodiments are potential claims that may be converted to claims in a future application. No modification of the following statements should be allowed to affect the interpretation of claims which may be drafted when this provisional application is converted into a regular utility application.

Embodiment 1 relates to a three dimensional (3D) printer comprising: a substrate plate; a plate heater; a metal plate, adjustable along a z-axis, having a first major surface and a second major surface opposite the first major surface, wherein the first major surface supports the substrate plate, and wherein the metal plate is thermally coupled to the plate heater; an extruder supported by a translation stage configured to move the extruder about an x-y plane, orthogonal to the z-axis, to positions above the substrate plate, the extruder including: a nozzle having a nozzle heater capable of heating the nozzle to at least 200° C.; and a heat tolerant filament drive mechanism to feed a printing material filament towards the nozzle; and a multi zone temperature controller coupled to the plate heater and the nozzle heater to independently control temperatures of the plate heater and the nozzle heater to facilitate extrusion of the printing material filament through the nozzle at a temperature exceeding 200° C. and onto the substrate plate that is heated by the plate heater to produce 3D structures.

Embodiment 2 relates to the 3D printer of Embodiment 1, wherein the metal plate comprises one or more orifices extending from the metal plate first major surface to the metal plate second major surface.

Embodiment 3 relates to the 3D printer of Embodiment 2, wherein at least one of the one or more orifices are fluidly coupled to a vacuum system.

Embodiment 4 relates to the 3D printer of Embodiments 2-3, wherein the metal plate comprises one or more grooves on at least the first major surface, the one or more grooves fluidly coupled to the one or more orifices.

Embodiment 5 relates to the 3D printer of Embodiments 1-4, wherein the substrate plate is a glass plate or a polymeric plate.

Embodiment 6 relates to the 3D printer of Embodiments 1-5, wherein the extruder is a dual extruder.

Embodiment 7 relates to the 3D printer of Embodiments 1-6 further comprising an air heater configured to heat the extruded material between the nozzle and the substrate plate.

Embodiment 8 relates to the 3D printer of Embodiment 7, wherein the air heater is mounted on a nozzle carriage assembly coupling the nozzle to the x-y translation stage.

Embodiment 9 relates to the 3D printer of Embodiments 1-8 further comprising an optical radiation source configured to heat the extruded material.

Embodiment 10 relates to the 3D printer of Embodiments 1-9 wherein the heat tolerant filament drive mechanism comprises metal to minimize distortion of the drive mechanism due to high temperatures corresponding to heating the nozzle to at least 200° C. and heating the glass plate to at least between 200-300° C. (e.g., 260° C.).

Embodiment 11 relates to the 3D printer of Embodiments 1-10 wherein the heat tolerant filament drive mechanism comprises a gear that engages the filament to feed the filament towards the nozzle.

Embodiment 12 relates to the 3D printer of Embodiment 11 wherein the gear is a metal gear.

Embodiment 13 relates to the 3D printer of Embodiments 1-12 and further comprising a nozzle carriage assembly coupling the nozzle to the x-y translation stage.

Embodiment 14 relates to the 3D printer of Embodiments 1-13 wherein the substrate plate is formed of a ceramic-glass material.

Embodiment 15 relates to the 3D printer of Embodiments 1-14 wherein the metal plate maintains uniform thermal coupling with the substrate plate at temperatures at least up to 200-300° C. (e.g., 260° C.).

Embodiment 16 relates to the 3D printer of Embodiments 1-15 and further comprising a printer controller coupled to control a position of the metal plate on the z-axis, the translation stage, and the heat tolerant filament drive mechanism.

Embodiment 17 relates to the 3D printer of Embodiments 1-16 and further comprising an electronic storage device having a 3D digital file, and wherein the printer controller is configured to access the 3D digital file and control the z-height of the metal plate, the x-y translation stage, and the heat tolerant filament drive mechanism to produce the 3D printed structure.

Embodiment 18 relates to the 3D printer of Embodiments 1-17 and further comprising a printing material filament spool to hold the printing material filament, and wherein the printer material filament comprises a polyetherimide having an extrusion temperature of at least approximately 200° C.

Embodiment 19 relates to a method of printing a 3D structure, the method comprising: adjusting, with a printer controller, a height of a z-height adjustable metal plate, the metal plate thermally coupled to a plate heater and a substrate plate; positioning, with the printer controller, an extruder, supported by an x-y translation stage, to positions above the substrate plate, the extruder including a nozzle having a nozzle heater capable of heating the nozzle to at least 200° C.; controlling, using the printer controller, a heat tolerant filament drive mechanism to feed a printing material filament towards the nozzle; and independently controlling, using an independent multi zone temperature controller coupled to the metal plate heater and the nozzle heater, the temperatures of the plate heater and nozzle heater to facilitate extrusion of the printing material filament through the nozzle at temperatures exceeding 200° C. onto the substrate plate that is heated by the plate heater to produce 3D structures.

Embodiment 20 relates to the method of Embodiment 19 wherein the heat tolerant filament drive mechanism comprises metal to minimize distortion of the drive mechanism due to high temperatures corresponding to heating the nozzle to at least 200° C. and heating the glass plate to at least between 200-300° C. (e.g., 260° C.).

Embodiment 21 relates to the method of Embodiments 19-20 wherein the heat tolerant filament drive mechanism comprises a gear that engages the filament to feed the filament towards the nozzle.

Embodiment 22 relates to the method of Embodiments 19-21 wherein the printer controller accesses a digital file from a storage device and wherein the printer controller controls the z-height of the metal plate, the x-y translation stage, and the heat tolerant filament drive mechanism to produce the 3D printed structure as a function of the accessed digital file.

Embodiment 23 relates to the method of Embodiments 19-22 and further comprising obtaining the printing material filament from a printing material filament spool holding the printing material filament, and wherein the printer material filament comprises a polyetherimide having an extrusion temperature of at least 200° C.

Embodiment 24 relates to the method of Embodiments 19-23 wherein the independent multi zone temperature controller receives sensed temperature information from separate temperature sensors for the plate heater and the nozzle heater and independently of the printer controller, controls the temperatures to separate set points, such that the nozzle temperature set point is at least 200° C. and the plate heater set point is between 200-300° C. (e.g., 260° C.).

Embodiment 25 relates to a 3D printing system comprising: a substrate plate; a plate heater; a metal plate, adjustable along a z-axis, having a first major surface and a second major surface opposite the first major surface, wherein the first major surface supports the substrate plate, and wherein the metal plate is thermally coupled to the plate heater; an extruder supported by a translation stage configured to move the extruder about an x-y plane, orthogonal to the z-axis, to positions above the substrate plate, the extruder including: a nozzle having a nozzle heater capable of heating the nozzle to at least 200° C.; and a heat tolerant filament drive mechanism to feed a printing material filament towards the nozzle; a printer controller coupled to receive a digital 3D file and control a z-height of the metal plate, the translation stage, and the heat tolerant filament drive mechanism as a function of the digital 3D file; and a multi zone temperature controller including temperature sensors, coupled to the plate heater and the nozzle heater to independently control temperatures of the plate heater and the nozzle heater to facilitate extrusion of the printing material filament through the nozzle at a temperature of at least 200° C. onto the substrate plate that is heated by the plate heater to a temperature of between 200-300° C. (e.g., 260° C.) to produce 3D structures.

Embodiment 26 relates to the system of Embodiment 25 wherein the heat tolerant filament drive mechanism comprises a metal drive wheel, the metal drive wheel engaging the filament and feeding the filament towards the heated nozzle.

Embodiment 27 relates to the system of Embodiments 25-26 and further comprising a nozzle carriage assembly coupling the nozzle to the x-y translation stage.

Embodiment 28 relates to the system of Embodiments 25-27 wherein the substrate plate is formed of a ceramic-glass material and wherein the metal plate maintains uniform thermal coupling with the substrate plate at temperatures up to 200-300° C. (e.g., 260° C.).

1. A three dimensional (3D) printer comprising:
a substrate plate;
a plate heater;
a metal plate, adjustable along a z-axis, having a first major surface and a second major surface opposite the first major surface, wherein the first major surface supports the substrate plate, and wherein the metal plate is thermally coupled to the plate heater;
an extruder supported by a translation stage configured to move the extruder about an x-y plane, orthogonal to the z-axis, to positions above the substrate plate, the extruder including:
a nozzle having a nozzle heater capable of heating the nozzle to at least 200° C.; and
a heat tolerant filament drive mechanism to feed a printing material filament towards the nozzle; and
a multi zone temperature controller coupled to the plate heater and the nozzle heater to independently control temperatures of the plate heater and the nozzle heater to facilitate extrusion of the printing material filament through the nozzle at a temperature exceeding 200° C. and onto the substrate plate that is heated by the plate heater to produce 3D structures.

2. The 3D printer of claim 1, wherein the metal plate comprises one or more orifices extending from the metal plate first major surface to the metal plate second major surface.

3. The 3D printer of claim 2, wherein at least one of the one or more orifices are fluidly coupled to a vacuum system.

4. The 3D printer of claim 2, wherein the metal plate comprises one or more grooves on at least the first major surface, the one or more grooves fluidly coupled to the one or more orifices.

5. The 3D printer of claim 1, wherein the substrate plate is a glass plate or a polymeric plate.

6. The 3D printer of claim 1, wherein the extruder is a dual extruder.

7. The 3D printer of claim 1 further comprising an air heater configured to heat the extruded material between the nozzle and the substrate plate.

8. The 3D printer of claim 7, wherein the air heater is mounted on a nozzle carriage assembly coupling the nozzle to the x-y translation stage.

9. The 3D printer of claim 1 further comprising an optical radiation source configured to heat the extruded material.

10. The 3D printer of claim 1 wherein the heat tolerant filament drive mechanism comprises metal to minimize distortion of the drive mechanism due to high temperatures corresponding to heating the nozzle to at least 200° C. and heating the glass plate to at least between 200-300° C.

11. The 3D printer of claim 1 and further comprising a nozzle carriage assembly coupling the nozzle to the x-y translation stage.

12. The 3D printer of claim 1 wherein the substrate plate is formed of a ceramic-glass material.

13. The 3D printer of claim 12 wherein the metal plate maintains uniform thermal coupling with the substrate plate at temperatures at least up to 200-300° C.

14. The 3D printer of claim 1 and further comprising a printer controller coupled to control a position of the metal plate on the z-axis, the translation stage, and the heat tolerant filament drive mechanism.

15. The 3D printer of claim 14 and further comprising an electronic storage device having a 3D digital file, and wherein the printer controller is configured to access the 3D digital file and control the z-height of the metal plate, the x-y translation stage, and the heat tolerant filament drive mechanism to produce the 3D printed structure.

16. The 3D printer of claim 1 and further comprising a printing material filament spool to hold the printing material filament, and wherein the printer material filament comprises a polyetherimide having an extrusion temperature of at least approximately 200° C.

17. A method of printing a 3D structure, the method comprising:
adjusting, with a printer controller, a height of a z-height adjustable metal plate, the metal plate thermally coupled to a plate heater and a substrate plate;
positioning, with the printer controller, an extruder, supported by an x-y translation stage, to positions above the substrate plate, the extruder including a nozzle having a nozzle heater capable of heating the nozzle to at least 200° C.;
controlling, using the printer controller, a heat tolerant filament drive mechanism to feed a printing material filament towards the nozzle; and
independently controlling, using an independent multi zone temperature controller coupled to the metal plate heater and the nozzle heater, the temperatures of the plate heater and nozzle heater to facilitate extrusion of the printing material filament through the nozzle at temperatures exceeding 200° C. onto the substrate plate that is heated by the plate heater to produce 3D structures.

18. The method of claim 17 wherein the heat tolerant filament drive mechanism comprises metal to minimize distortion of the drive mechanism due to high temperatures corresponding to heating the nozzle to at least 200° C. and heating the glass plate to at least between 200-300° C.

19. A 3D printing system comprising:
a substrate plate;
a plate heater;
a metal plate, adjustable along a z-axis, having a first major surface and a second major surface opposite the first major surface, wherein the first major surface supports the substrate plate, and wherein the metal plate is thermally coupled to the plate heater;
an extruder supported by a translation stage configured to move the extruder about an x-y plane, orthogonal to the z-axis, to positions above the substrate plate, the extruder including:
a nozzle having a nozzle heater capable of heating the nozzle to at least 200° C.; and
a heat tolerant filament drive mechanism to feed a printing material filament towards the nozzle;
a printer controller coupled to receive a digital 3D file and control a z-height of the metal plate, the translation stage, and the heat tolerant filament drive mechanism as a function of the digital 3D file; and
a multi zone temperature controller including temperature sensors, coupled to the plate heater and the nozzle heater to independently control temperatures of the plate heater and the nozzle heater to facilitate extrusion of the printing material filament through the nozzle at a temperature of at least 200° C. onto the substrate plate that is heated by the plate heater to a temperature of between 200-300° C. to produce 3D structures.

20. The system of claim 19 wherein the heat tolerant filament drive mechanism comprises a metal drive wheel, the metal drive wheel engaging the filament and feeding the filament towards the heated nozzle.
